(19) United States
(12) Patent Application Publication
(10) Pub. No.: US 2026/0219699 A1
(43) Pub. Date: Jul. 30, 2026

(54) POWER CONTROL DEVICE

(71) Applicant: Niterra Co., Ltd., Nagoya-shi, Aichi (JP)

(72) Inventors: Shinji KUMAZAWA, Nagoya-shi, Aichi (JP); Tomonori UEMURA, Nagoya-shi, Aichi (JP)

(73) Assignee: Niterra Co., Ltd., Nagoya-shi, Aichi (JP)

(21) Appl. No.: 19/152,305

(22) PCT Filed: Apr. 2, 2024
(86) PCT No.: PCT/JP2024/013633

§ 371 Date: Jul. 30, 2025

(30) Foreign Application Priority Data
May 23, 2023 (JP) 2023-084312

(51) Int. Cl. G05F 1/67

(52) U.S. Cl. CPC G05F 1/67

(57) ABSTRACT

A power control device (10) includes a power conversion section (30) which converts and outputs the voltage of power inputted from a solar cell panel (2), a control section (28) which performs tracking control for the power conversion section (30) after performing search control for the power conversion section (30), and an abnormality determination section (29) which determines that an abnormality has occurred. In the tracking control, the abnormality determination section (29) changes a change target, which is one of voltage, current, and power on the input side of the power conversion section (30), in a prescribed target period and determines that an abnormality has occurred, on the basis of a change of the change target in the target period.

### TECHNICAL FIELD

The present disclosure relates to a power control device.

### BACKGROUND ART

A power conditioner is disclosed in Patent Literature 1. This power conditioner finds out a maximum power point (MPP), at which generated power becomes the maximum, by MPPT control; i.e., maximum power point tracking control.

### CITATION LIST

### Patent Literature

Patent Literature 1: JP2020-52532A

### SUMMARY OF INVENTION

### Technical Problem

In the technique disclosed in Patent Literature 1, an abnormal state may occur due to, for example, deterioration of a solar cell panel or deterioration of an electricity conducting path that transfers power from the solar cell panel. It is desired that the technique disclosed in Patent Literature 1 be able to determine such an abnormal state.

An object of the present disclosure is to provide a technique which enables determination of an abnormality of a solar cell panel or an electricity conducting path for transferring power from the solar cell panel.

### Solution to Problem

A power control device of the present disclosure is a power control device which controls power inputted from a solar cell panel and determines that an abnormality has occurred, on the basis of voltage, current, or power inputted from the solar cell panel, the power control device comprising:
a power conversion section which converts and outputs the voltage inputted from the solar cell panel;
a control section which performs tracking control for the power conversion section after performing search control for the power conversion section; and
an abnormality determination section which determines that an abnormality has occurred,
wherein voltage or current on one side of the power conversion section, the one side being an input side or an output side of the power conversion section, is used as an adjustment target in the search control, and the search control changes the adjustment target stepwise by a prescribed width in each of steps, and detects, as a maximum power, a power which is the maximum among powers on the one side in the steps,
wherein the tracking control causes the power on the one side of the power conversion section to follow the maximum power detected by the search control, and
wherein, in the tracking control, the abnormality determination section changes a change target, which is one of voltage, current, and power on the input side of the power conversion section, in a prescribed target period such that the change target increases and decreases between two values set beforehand and determines that an abnormality has occurred, on the basis of a change of the change target in the target period.

### Advantageous Effect of Invention

According to the present disclosure, it is possible to determination an abnormality of a solar cell panel or an electricity conducting path for transferring power from the solar cell panel.

### BRIEF DESCRIPTION OF DRAWINGS

FIG. 1 is a block diagram schematically showing, as an example, the configuration of a vehicle which includes a power control device for solar cell panels according to a first embodiment.

FIG. 2 is a circuit diagram schematically showing, as an example, an MPPT circuit, a control section, and an abnormality determination section which are included in the power control device of FIG. 1.

FIG. 3 is a graph which shows, in a related manner, the relation between elapsed time and input voltage, the relation between elapsed time and input current, and the relation between elapsed time and input power during first search control.

FIG. 4 is a graph showing a change of input side current value when a target current was temporarily changed during tracking control.

FIG. 5 is a graph showing a change of input side current value when a changing process was performed a plurality of times in a second embodiment.

FIG. 6 is a graph showing a change of input side current value when the input side current value was changed periodically in a third embodiment.

### DESCRIPTION OF EMBODIMENTS

### [Description of Embodiments of the Present Disclosure]

In the following, embodiments of the present disclosure are listed and shown as examples.

[1] A power control device which controls power inputted from a solar cell panel and determines that an abnormality has occurred, on the basis of voltage, current, or power inputted from the solar cell panel, the power control device comprising:
a power conversion section which converts and outputs the voltage inputted from the solar cell panel;
a control section which performs tracking control for the power conversion section after performing search control for the power conversion section; and
an abnormality determination section which determines that an abnormality has occurred,
wherein voltage or current on one side of the power conversion section, the one side being an input side or an output side of the power conversion section, is used as an adjustment target in the search control, and the search control changes the adjustment target stepwise by a prescribed width in each of steps, and detects, as a maximum power, a power which is the maximum among powers on the one side in the steps,
wherein the tracking control causes the power on the one side of the power conversion section to follow the maximum power detected by the search control, and
wherein, in the tracking control, the abnormality determination section changes a change target, which is one of voltage, current, and power on the input side of the power conversion section, in a prescribed target period such that the change target increases and decreases between two values set beforehand and determines that an abnormality has occurred, on the basis of a change of the change target in the target period.

In the case where an abnormality which causes a change in impedance has occurred in the solar cell panel or the electricity conducting path for transferring the power from the solar cell panel, that abnormality affects the response to a change of the change target. In view of this, the above-described power control device changes the change target in the target period and determines that an abnormality has occurred, on the basis of the change of the change target in the target period. As a result, the above-described power control device can determine the abnormality of the solar cell panel or the electricity conducting path for transferring the power from the solar cell panel.

[2] The power control device described in [1], wherein, in the target period, the abnormality determination section performs a plurality of times a process of measuring a value corresponding to a change of the change target at the time when the change target is changed, and the abnormality determination section determines that an abnormality has occurred, on the basis of the average of measured values.

The above-described power control device can determine the abnormality more accurately by determining that an abnormality has occurred, on the basis of the average of the plurality of measured values in the same target period.

[3] The power control device described in [1], wherein the abnormality determination section periodically changes the change target at a plurality of frequencies in the target period and determines that an abnormality has occurred, on the basis of a change of the change target at each frequency.

The frequency at which an abnormality of response is observed changes depending on the cause of the abnormality. Since the above-described power control device periodically changes the change target at a plurality of frequencies and determines that an abnormality has occurred, on the basis of a change at each frequency, the above-described power control device can determine, for a plurality of causes of the abnormality, that an abnormality has occurred.

[4] The power control device described in [1] or [2], wherein the abnormality determination section determines that an abnormality has occurred, on the basis of the value of the change target at the time when the change target is changing.

The above-described power control device can determine that an abnormality has occurred, on the basis of the results of the determination as to whether or not the value of the change target is changing normally.

[5] The power control device described in [1] or [3], wherein the abnormality determination section determines that an abnormality has occurred, on the basis of the amplitude of the change target at the time when the change target is periodically changed in the target period.

The above-described power control device can determine that an abnormality has occurred in the case where the amplitude of the change target is abnormal.

[6] The power control device described in any one of [1] to [5], wherein the power control device controls power inputted from the solar cell panel mounted on a vehicle,
wherein the solar cell panel includes a plurality of solar cell modules connected in series and a bypass diode connected in parallel to the solar cell modules,
wherein the control section is configured to calculate a differential conductance di/dv on an I-V curve which represents the correlation between current and voltage outputted from the solar cell panel, and
wherein, in the case where the absolute value of the differential conductance di/dv becomes equal to or smaller than a previously set threshold value in the search control, the control section determines that the bypass diode has operated and performs the search control and the tracking control within a range of voltage or current on the input side within which the bypass diode does not operate.

In a state in which the bypass diode operates at all times, the above-described power control device can perform the search control by lowering the voltage to a voltage at which the bypass diode does not operate.

[7] The power control device described in any one of [1] to [6], wherein the abnormality determination section performs a changing process of changing the change target in the target period and a measurement process of measuring a value corresponding to a change of the charge target, and the abnormality determination section determines that an abnormality has occurred, on the condition that an amount of change of voltage, current, or power on the one side, which change occurred in the changing process, is equal to or smaller than a determination value.

The above-described power control device can easily avoid erroneous determination of abnormality due to changes in the external environment in the middle of the changing process.

[8] The power control device described in any one of [1] to [7], wherein the abnormality determination section determines that an abnormality has occurred, on the condition that an amount of change of voltage, current, or power on the one side, which change occurred in the target period, is equal to or smaller than a determination value.

The above-described power control device can easily avoid erroneous determination of abnormality due to changes in the external environment in the middle of the target period.

[9] The power control device described in any one of [1] to [8], wherein the abnormality determination section and the control section are configured by a common control circuit.

In the above-described power control device, the configurations of the control section and the abnormality determination section can be simplified by constituting the control section and the abnormality determination section by the same control circuit.

### [Details of Embodiments of the Present Disclosure]

### 1. First Embodiment

### 1-1. Outline of On-vehicle System

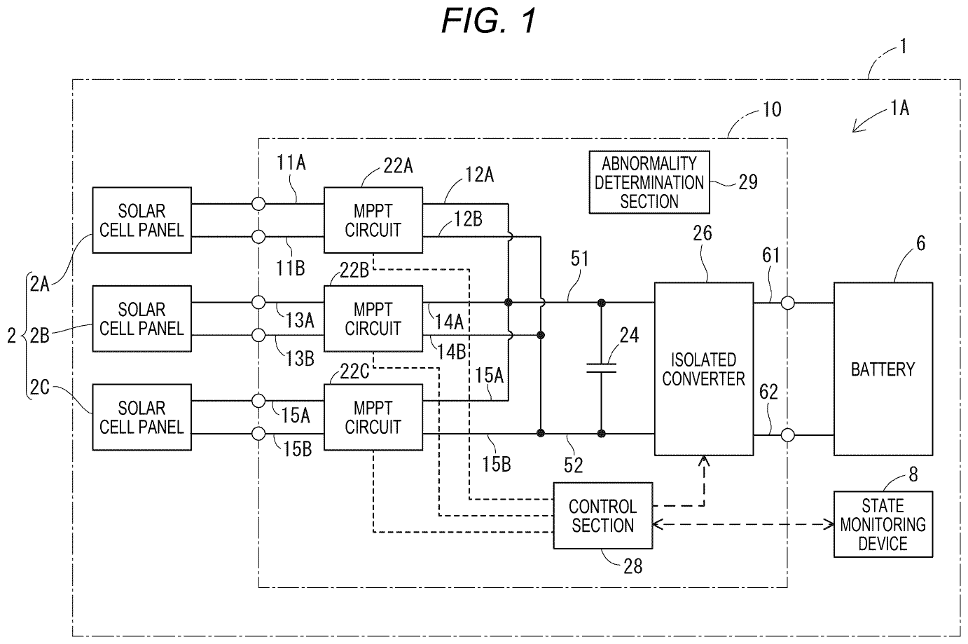

An on-vehicle system 1A, which is a power control system mounted on a vehicle 1, is shown, as an example, in FIG. 1. The on-vehicle system 1A includes solar cell panels 2, a power control device 10, a battery 6, and a state monitoring device 8. No particular limitation is imposed on the type of the vehicle 1, and the vehicle 1 may be, for example, an electric vehicle or a hybrid vehicle, so long as the vehicle is a mobile body.

Each solar cell panel 2 is configured, for example, by connecting a plurality of solar cells, each of which converts light energy to electric power, and outputs to the power control device 10 the power generated by the plurality of solar cells in accordance with irradiation light. A plurality of such solar cell panels 2 are provided in the vehicle 1. Each of the plurality of solar cell panels 2 is electrically connected to the power control device 10. Specifically, the plurality of solar cell panels 2 include solar cell panels 2A, 2B, and 2C. These three solar cell panels 2A, 2B, and 2C are disposed at different positions in the vehicle 1 such that they are exposed to the outside. The solar cell panel 2A is electrically connected to a first MPPT circuit 22A (hereinafter, referred to also as MPPT 22A), which will be described later, and can supply power to the MPPT circuit 22A. The solar cell panel 2B is electrically connected to a second MPPT circuit 22B (hereinafter, referred to also as MPPT 22B), which will be described later, and can supply power to the MPPT circuit 22B. The solar cell panel 2C is electrically connected to a third MPPT circuit 22C (hereinafter, referred to also as MPPT 22C), which will be described later, and can supply power to the MPPT circuit 22C.

The battery 6 is a vehicle battery. The battery 6 is, for example, a high-voltage battery which can supply power to a drive motor (motor for providing motive power to wheels of the vehicle). For example, a lithium ion battery or the like is suitably used as the battery 6. The battery 6 can output a prescribed DC voltage from its opposite ends. A high-potential-side electrode of the battery 6 is electrically connected to an electricity conducting path 61, and a low-potential-side electrode of the battery 6 is electrically connected to an electricity conducting path 62.

The state monitoring device 8 is configured as a control device including a detection section, a communication section, an information processing section, etc. and has a function of monitoring the state of the battery 6 and a function of communicating with external devices. For example, the state monitoring device 8 has a function of detecting the output voltage of the battery 6 (voltage between the opposite ends) and sending the output voltage of the battery 6 to the control section 28. The output voltage of the battery 6 is the potential difference between the potential of a high-potential side electrode whose potential is the highest in the battery 6 and the potential of a low-potential side electrode whose potential is the lowest in the battery 6.

Although detailed illustrations are omitted, the on-vehicle system 1A includes a battery management system (BMS) which has a function of preventing overcharge and overdischarge of the cells of the battery 6, a function of preventing overcurrent of the cells, a function of managing the temperatures of the cells, a function of calculating the quantity of electric energy remaining in the battery, a function of equalizing the cell voltages (cell balance), etc.

The power control device 10 is a power control device for solar cell panels. The power control device 10 can receive power from each of the plurality of solar cell panels 2A, 2B, and 2C and can supply output power based on this power to the battery 6. The power control device 10 has a function of controlling the power inputted from the solar cell panels 2 and can perform step-down operation and step-up operation therein.

### 1-2. Basic Configuration of Power Control Device

The power control device 10 includes a plurality of MPPT circuits 22A, 22B, and 22C, a capacitor 24, an isolated converter 26, a control section 28, and an abnormality determination section 29.

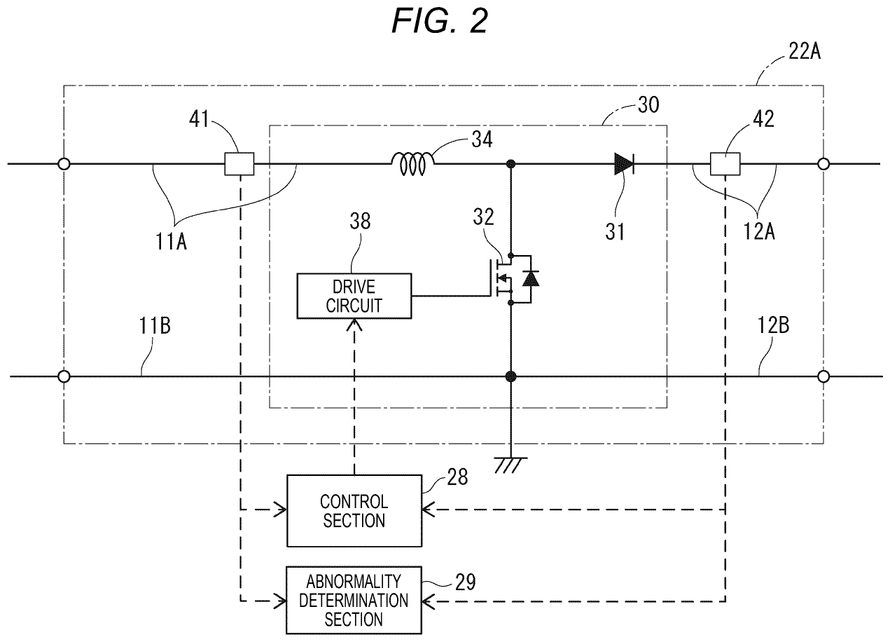

Of the plurality of MPPT circuits 22A, 22B, and 22C, a circuit which is connected to the solar cell panel 2A and to which power is supplied from the solar cell panel 2A is the first MPPT circuit 22A. A circuit which is connected to the solar cell panel 2B and to which power is supplied from the solar cell panel 2B is the second MPPT circuit 22B. A circuit which is connected to the solar cell panel 2C and to which power is supplied from the solar cell panel 2C is the third MPPT circuit 22C. The first MPPT circuit 22A, the second MPPT circuit 22B, and the third MPPT circuit 22C have the same circuit configuration and the same function although their input sides are connected to different solar cell panels. Each of the first MPPT circuit 22A, the second MPPT circuit 22B, and the third MPPT circuit 22C is controlled by the control section 28. Although the following description relates mainly to the first MPPT circuit 22A shown in FIG. 2, each of the second MPPT circuit 22B and the third MPPT circuit 22C has the same circuit configuration as the first MPPT circuit 22A.

Electricity conducting paths 11A and 11B are electricity conducting paths for supplying power based on power generation in the solar cell panel 2A to the power conversion section 30. The electricity conducting path 11A is an electricity conducting path through which input current based on the power supplied from the solar cell panel 2A flows toward the power conversion section 30. The electricity conducting paths 11A and 11B are electricity conducting paths to which input voltage based on the power supplied from the solar cell panel 2A can be applied. Electricity conducting paths 12A and 12B are electricity conducting paths to which the power supplied from the first MPPT circuit 22A is transferred. The electricity conducting path 12A is an electricity conducting path through which the output current supplied from the first MPPT circuit 22A flows. The electricity conducting paths 12A and 12B are electricity conducting paths to which the output voltage supplied from the first MPPT circuit 22A can be applied.

The MPPT circuit 22A includes a power conversion section 30, detection sections 41 and 42, etc. The MPPT circuit 22A is a circuit which can be controlled by the control section 28. The MPPT circuit 22A is a circuit which can operate in an MPPT (maximum power point tracking) mode under the control by the control section 28.

The power conversion section 30 is configured as a non-isolated DC-DC converter; specifically, as a known chopper circuit. The power conversion section 30 is provided between the pair of electricity conducting paths 11A and 11B and the pair of electricity conducting paths 12A and 12B, performs step-up operation for the input power based on the power supplied from the solar cell panel 2A (i.e., so as to increase the voltage supplied from the solar cell panel 2A), and performs power conversion so as to supply output power. In the case where the power conversion section 30 performs the above-described step-up operation, on the basis of the input voltage applied between the pair of electricity conducting paths 11A and 11B, the power conversion section 30 performs voltage step up such that an output voltage higher than the input voltage is applied between the pair of electricity conducting paths 12A and 12B. The voltage applied to the electricity conducting path 11A is the voltage of the electricity conducting path 11A with respect to the electricity conducting path 11B; specifically, the potential difference between the electricity conducting paths 11A and 11B. The voltage applied to the electricity conducting path 12A is the voltage of the electricity conducting path 12A with respect to the electricity conducting path 12B; specifically, the potential difference between the electricity conducting paths 12A and 12B.

In the example of FIG. 2, the power conversion section 30 has a circuit configuration which can perform step-up operation. However, the circuit configuration of the power conversion section 30 may be changed to a circuit configuration which can perform step-down operation or a circuit configuration which can perform both of step-up operation and step-down operation. For example, in the case where the power conversion section 30 is configured to perform step-down operation, on the basis of the voltage applied between the pair of electricity conducting paths 11A and 11B, the power conversion section 30 performs voltage step down such that a voltage lower than that voltage is applied between the pair of electricity conducting paths 12A and 12B.

The power conversion section 30 includes a first element 31, a second element 32, an inductor 34, a drive circuit 38, etc.

One end of the inductor 34 is connected to a connection portion between the first element 31 and the second element 32, and thus is electrically connected to the anode of the first element 31 and the drain of the second element 32. The other end of the inductor 34 is electrically connected to the electricity conducting path 11A (specifically, a portion of the electricity conducting path 11A located on the power conversion section 30 side in relation to the detection section 41). The first element 31 is a diode. The anode of the diode is electrically connected to the inductor 34 and the second element 32, and the cathode of the diode is electrically connected to the electricity conducting path 12A (specifically, a portion of the electricity conducting path 12A located on the power conversion section 30 side in relation to the detection section 42). The second element 32 is a semiconductor switch element (in the example of FIG. 2, an N-channel-type MOSFET). The electricity conducting paths 11B and 12B are electrically connected to the source of the second element 32. Activation and deactivation signals from the drive circuit 38 are inputted to the gate of the second element 32. The second element 32 comes into an ON state when an activation signal (high-level signal) is applied to the gate from the drive circuit 38. The second element 32 comes into an OFF state when a deactivation signal (low-level signal) is applied to the gate from the drive circuit 38.

The detection section 41 includes a current detection section and a voltage detection section. The detection section 41 is provided in the middle of the electricity conducting path 11A. The current detection section of the detection section 41 gives a detection value to the control section 28 and the abnormality determination section 29, the detection value enabling determination of a current value at the detection position of the current detection section in the electricity conducting path 11A. The voltage detection section of the detection section 41 gives another detection value to the control section 28 and the abnormality determination section 29, the detection value enabling determination of a voltage value (voltage value between the electricity conducting paths 11A and 11B) at the detection position of the voltage detection section in the electricity conducting path 11A.

The detection section 42 includes a current detection section and a voltage detection section. The detection section 42 is provided in the middle of the electricity conducting path 12A. The current detection section of the detection section 42 gives a detection value to the control section 28 and the abnormality determination section 29, the detection value enabling determination of a current value at the detection position of the current detection section in the electricity conducting path 12A. The voltage detection section of the detection section 42 gives another detection value to the control section 28 and the abnormality determination section 29, the detection value enabling determination of a voltage value (voltage value between the electricity conducting paths 12A and 12B) at the detection position of the voltage detection section in the electricity conducting path 12A.

The control section 28 includes, for example, a CPU for performing various arithmetic processes, a storage section (ROM, RAM, etc.) for storing various pieces of information, a communication section which is a communication interface for communicating with external devices, and so on. The detection signals from the detection sections 41 and 42 are given to the control section 28. The control section 28 can cause the power conversion sections 30 to perform step-up operation and/or step-down operation. Specifically, the control section 28 outputs a PWM signal to each of the drive circuits provided in the plurality of MPPT circuits 22A, 22B, and 22C (in the first MPPT circuit 22A of FIG. 2, the drive circuit 38). Each drive circuit outputs a PWM signal synchronized with the PWM signal given thereto from the control section 28.

One electrode of the capacitor 24 is electrically connected to an electricity conducting path 51, and the other electrode of the capacitor 24 is electrically connected to an electricity conducting path 52. The capacitor 24 can be charged and discharged between the pair of electricity conducting paths 51 and 52. The electricity conducting path 51 is electrically connected to the electricity conducting paths 12A, 14A, and 16A such that electrical continuity is established between the electricity conducting path 51 and each of the electricity conducting paths 12A, 14A, and 16A. The electricity conducting path 52 is electrically connected to the electricity conducting paths 12B, 14B, and 16B such that electrical continuity is established between the electricity conducting path 52 and each of the electricity conducting paths 12B, 14B, and 16B.

The isolated converter 26 is an isolated-type DC-DC converter. The isolated converter 26 can perform step-up operation of stepping up the voltage applied between the pair of electricity conducting paths 51 and 52 and applying the stepped up DC voltage to the electricity conducting paths 61 and 62. The isolated converter 26 can perform step-down operation of stepping down the voltage applied between the pair of electricity conducting paths 61 and 62 and applying the stepped down DC voltage to the electricity conducting paths 51 and 52. Control of the isolated converter 26 is performed, for example, by the control section 28.

The abnormality determination section 29 determines that an abnormality has occurred. The abnormality determination section 29 is configured to include, for example, a CPU for performing various arithmetic processes, a storage section (ROM, RAM, etc.) for storing various pieces of information, a communication section which is a communication interface for communicating with external devices, and so on. In the present embodiment, the abnormality determination section 29 is configured by the same control circuit as the control section 28. However, the abnormality determination section 29 may be configured by a different control circuit. The detection signals from the detection section 41 are given to the abnormality determination section 29. The abnormality determination section 29 determines that an abnormality has occurred, on the basis of the detection signals from the detection section 41.

### 1-3. Operation of Power Control Device

In the following description, “one side” means the side where the solar cell panels 2 are present when the power conversion section 30 is considered as a reference, and in the MPPT circuit 22A, “one side” means the side where the electricity conducting paths 11A and 11B are present. The “voltage on the one side” (hereinafter referred to as the “one-side voltage”) means the voltage applied between the electricity conducting paths 11A and 11B, the “current on the one side” (hereinafter referred to as the “one-side current”) means the current flowing through the electricity conducting path 11A, and the “power on one side” (hereinafter referred to as the “one-side power”) means the power transferred by the electricity conducting paths 11A and 11B.

In the power control apparatus 10, the control section 28 can perform power regulation control. The power regulation control is control of performing tracking control after search control. The control section 28 may execute the search control for the power conversion section 30 at prescribed constant intervals (for example, intervals of 60 to 600 seconds), or execute the search control for the power conversion section 30 when the control section 28 determines that the sunlight irradiation condition of the solar cell panels 2 has changed suddenly. After the search control, the control section 28 executes for the power conversion section 30 the tracking control which reflects the search control. Specifically, in the case where the control section 28 has performed the search control for the power conversion section 30 at a certain timing, during a period between the end of the search control and the arrival of a timing at which the next search control starts, the control section 28 executes the tracking control for the power conversion section 80 such that the above-described “one-side power” follows the maximum power obtained in the latest search control. The control section 28 repeatedly executes the “power regulation control of performing the tracking control after performing the search control” in this manner. The search control executed by the control section 28 includes first search control and second search control.

In the first search control, the power conversion section 30 is controlled so as to increase stepwise the current flowing through the electricity conducting path 11A (the one-side current) by a first current width A1, while the power conversion section 30 is caused to perform power conversion operation (specifically, the above-described step-up operation). In addition, on the basis of the power of the electricity conducting paths 11A and 11B (the one-side power) in each of steps of increasing stepwise the current flowing through the electricity conducting path 11A by the first current width A1, the maximum power (the first maximum power) of the electricity conducting paths 11A and 11B in all the steps in which the current has been increased stepwise is detected.

In the first search control, the control section 28 performs on-off control (specifically, PWM control) so as to give an on-off signal (specifically, a PWM (pulse width modulation) signal) to the second element 32 such that activation and deactivation signals are alternately and repeatedly given to the second element 32, thereby turning the second element 32 on and off, whereby the control section 28 causes the power conversion section 30 to perform step-up operation. In the present embodiment, in both of the search control and the tracking control, the frequency of the PWM signal outputted by the control section 28 and the frequency of the PWM signal outputted to the second element 32 by the drive circuit 38 are 1 kHz or higher, desirably 100 kHz or higher. Notably, the frequency of the PWM signal is desirably 1000 kHz or lower from the viewpoints of EMC (electro magnetic compatibility) and the losses at high frequences of a switching device and peripheral elements which are used.

By such PWM control, the control section 28 controls the power conversion section 30 so as to increase stepwise the current flowing through the electricity conducting path 11A (the one-side current) by the first current width Δ1, while causing the power conversion section 30 to perform the step-up operation. During the first search control, the control section 28 adjusts the duty of the above-described PWM signal so as to render the current flowing through the electricity conducting path 11A (the one-side current) coincident with a target current in each step. For example, in a situation in which the current flowing through the electricity conducting path 11A must be rendered coincident with I1 in the first search control, the control section 28 adjusts the duty of the PWM signal given to the gate of the second element 32 to maintain the current flowing through the electricity conducting path 11A at I1, while monitoring the current flowing through the electricity conducting path 11A by obtaining the value detected by the detection section 41. In the case where the control section 28 changes stepwise the current flowing through the electricity conducting path 11A in the first search control, the control section 28 sets the length T1 of the period of each step to be 0.05 ms or greater and less than 100 ms. In a representative example, T1 is, for example, 1 ms.

In the case where the first target current immediately after the first search control has been started is I1, after having performed an adjustment for rendering the current flowing through the electricity conducting path 11A coincident with I1 (adjustment in the first step) for the time T1, the control section 28 performs an adjustment for rendering the current flowing through the electricity conducting path 11A coincident with I1+Δ1 by increasing the target current by Δ1 (adjustment in the second step), and subsequently performs an adjustment for rendering the current flowing through the electricity conducting path 11A coincident with I1+Δ1×2 by further increasing the target current by Δ1 (adjustment in the third step). In this manner, the control section 28 increases stepwise the current flowing through the electricity conducting path 11A at intervals of the time T1 such that the target current in the n-th step becomes I1+Δ1×(n−1), while causing the power conversion section 30 to perform the above-described step-up operation.

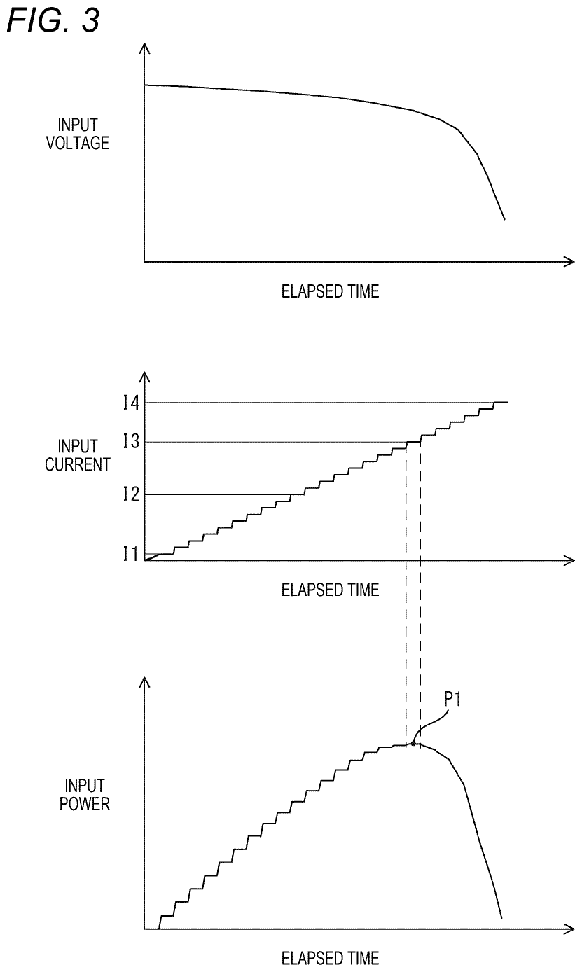

The graph in the middle row of FIG. 3 is a graph showing the relation between elapsed time and input current (the current flowing through the electricity conducting path 11A) during such first search control. In the graph of FIG. 3, I1 represents the above-described first target current, and I4 represents the last target current; i.e., the target current in the last step among all the steps. Namely, in the example of FIG. 3, the current is increased stepwise from a current value I1 to a current value I4 by Δ1 at a time. The graph in the upper row of FIG. 3 is a graph showing the relation between elapsed time and input voltage (the voltage applied between the electricity conducting paths 11A and 11B) during the first search control. The graph in the lower row of FIG. 3 is a graph showing the relation between elapsed time and input power (the power supplied via the electricity conducting paths 11A and 11B) during the first search control. Δ1 is, for example, one Xth of the rated current or the maximum current of the solar cell panel 2A which supplies power to the power conversion section 30. The value of X can be greater than the number of the steps in the above-described first search control. Δ1 desirably falls within the range of, for example, 1% to 10% of the rated current of the solar cell panel 2A.

The control section 28 detects the power of the electricity conducting paths 11A and 11B (the one-side power) in each step when it increases stepwise the current flowing through the electricity conducting path 11A by the first current width Al as shown in the graph in the middle row of FIG. 3. Specifically, in the period of a time T1 of each step, the control section 28 detects the power of the electricity conducting paths 11A and 11B a prescribed number of times (N times) at constant sampling intervals in the period of a time T2 after elapse of a prescribed time T3 (T3=T1−T2) from the start point in time to, and the control section 28 evaluates N detected power values by using a prescribed statistical method, thereby calculating the power in each step. The “evaluation using a prescribed statistical method” may be, for example, the average of the N detected power values, the median among the N detected power values, or the average of the N detected power values from which the maximum and minimum values have been removed. Other statistical methods may be used. In the representative example, the average of the N detected power values is used. For example, in the period of the time T1 in the first step in which the current flowing through the electricity conducting path 11A is rendered coincident with I1, the power of the electricity conducting paths 11A and 11B is detected N times (i.e., N power values are detected) at constant sampling intervals in the period of the time T2 after elapse of the prescribed time T3 (T3=T1−T2) from the start point of the first step, and the average of the N detected power values is used as the power value in the first step (the period of current value I1). For the periods of the second step, the third step, etc., the control section 28 calculates power values in the same manner. The control section 28 performs such first search control in all of the prescribed number of steps so as to obtain the power values in all the steps, and employs, as first maximum power, the maximum value among the power values in all the steps. In the example of the graph in the middle row of FIG. 3, the first maximum power is P1, and the input current (the current flowing through the electricity conducting path 11A) in the period in which the first maximum power P1 was obtained is I3. Notably, the time T3 is a time whose length is a prescribed fraction of the length T1, and the time zone of the time T2 is a time zone after the time whose length is the prescribed fraction of the length T1 has elapsed in each period.

The control section 28 performs the second search control after the above-described first search control before performing the next tracking control. In the second search control, the power conversion section 30 is controlled so as to increase stepwise the current flowing through the electricity conducting path 11A (the one-side current) by a second current width 42, while the power conversion section 30 is caused to perform the step-up operation. In addition, on the basis of the power of the electricity conducting paths 11A and 11B (the one-side power) in each step of increasing stepwise the current flowing through the electricity conducting path 11A by the second current width 42, the maximum power (the second maximum power) of the electricity conducting paths 11A and 11B in all the steps in which the current has been increased stepwise is detected. The control of each step of the second search control is the same as the control of each step of the first search control. The second current width 42 is smaller than the first current width A1 and desirably falls within the range of, for example, 1% to 50% of Δ1.

The start current value 12 in the second search control is smaller than the value I3 of the input current (the current flowing through the electricity conducting path 11A) at the first maximum power in the above-described first search control and larger than the current value I1, which is the smallest among the current values in the steps of the first search control. In the example of FIG. 3, the start current value I2 is a value obtained by subtracting a prescribed current value from the current value I3, the prescribed current value corresponding to Z steps of the first search control. The start current value I2 can be represented by, for example, an expression of I2=I3−Δ1×Z. Although the value of Z is 8 in the example of FIG. 3, the value of Z may be other than 8. In the second search control, the current flowing through the electricity conducting path 11A (the one-side current) is increased stepwise from this start current value I2 by the second current width Δ2. In the second search control as well, the control section 28 performs the above-described PWM control so as to give the PWM signal to the second element 32, thereby causing the power conversion section 30 to perform the step-up operation.

By such PWM control, the control section 28 controls the power conversion section 30 so as to increase stepwise the current flowing through the electricity conducting path 11A (the one-side current) by the second current width 42, while causing the power conversion section 30 to perform the step-up operation. During the second search control as well, the control section 28 adjusts the duty of the above-described PWM so as to render the current flowing through the electricity conducting path 11A (the one-side current) coincident with the target current in each step. For example, in a situation in which the current flowing through the electricity conducting path 11A must be rendered coincident with I2 in the second search control, the control section 28 adjusts the duty of the PWM signal given to the gate of the second element 32 to maintain the current flowing through the electricity conducting path 11A at I2, while monitoring the current flowing through the electricity conducting path 11A by obtaining the value detected by the detection section 41. In the second search control as well, in the case where the control section 28 changes stepwise the current flowing through the electricity conducting path 11A, the control section 28 sets the length T1 of the period of each step to be 0.05 ms or greater and less than 100 ms. In the representative example, T1 is, for example, 1 ms.

In the case where the first target current immediately after the second search control has been started is I2, after having performed an adjustment for rendering the current flowing through the electricity conducting path 11A coincident with I2 (adjustment in the first step) for the time T1, the control section 28 performs an adjustment for rendering the current flowing through the electricity conducting path 11A coincident with I2+Δ2 by increasing the target current by Δ2 (adjustment in the second step), and subsequently performs an adjustment for rendering the current flowing through the electricity conducting path 11A coincident with I2+Δ2×2 by further increasing the target current by Δ2 (adjustment in the third step). In this manner, the control section 28 increases stepwise the current flowing through the electricity conducting path 11A at intervals of the time T1 such that the target current in the m-th step becomes I2+Δ2×(m−1), while causing the power conversion section 30 to perform the above-described step-up operation.

During the second search control, the control section 28 detects the power of the electricity conducting paths 11A and 11B (the one-side power) in each step when it increases stepwise the current flowing through the electricity conducting path 11A by the second current width 42. Specifically, in the period of the time T1 of each step, the control section 28 detects the power of the electricity conducting paths 11A and 11B a prescribed number of times (N times) at constant sampling intervals in the period of the time T2 after elapse of a prescribed time T3 (T3=T1−T2) from the start point in time to, and the control section 28 evaluates N detected power values by using a prescribed statistical method, thereby calculating the power in each step. The “evaluation using a prescribed statistical method” may be, for example, the average of the N detected power values, the median among the N detected power values, or the average of the N detected power values from which the maximum and minimum values have been removed. Other statistical methods may be used. In the representative example, the average of N detected power values is used. For example, in the period of the time T1 in the first step in which the current flowing through the electricity conducting path 11A is rendered coincident with I2, the power of the electricity conducting paths 11A and 11B is detected N times (i.e., N power values are detected) at constant sampling intervals in the period of the time T2 after elapse of the prescribed time T3 (T3=T1−T2) from the start point of the first step, and the average of the N detected power values is used as the power value in the first step (the period of current value I2). For the periods of the second step, the third step, etc., the control section 28 calculates power values in the same manner. The control section 28 performs such second search control in all the steps (between the current value I2 and the current value I4) so as to obtain the power values in all the steps, and employs, as second maximum power P2, the maximum value among the power values in all the steps.

The tracking control is control which causes the power on one side of the power conversion section 30 to follow the second maximum power P2 detected by the search control. Specifically, the tracking control is control which causes the power conversion section 30 to perform the step-up operation such that the input power of the power conversion section 30 (powers supplied via the electricity conducting paths 11A and 11B) is rendered coincident with the above-described power P2. In a situation in which the input power supplied via the electricity conducting paths 11A and 11B must be rendered coincident with P2 in the tracking control, the control section 28 adjusts the duty of the PWM signal given to the gate of the second element 32 so as to render the input power supplied via the electricity conducting paths 11A and 11B coincident with P2 while monitoring the current flowing through the electricity conducting path 11A and the voltage between the electricity conducting paths 11A and 11B by obtaining the values detected by the detection section 41. For example, the control section 28 sets the target current such that the input power is rendered coincident with the second maximum power P2 and causes the power conversion section 30 to perform the step-up operation such the current value on the input side becomes equal to the target current.

Notably, in the above description, the step-up operation and the step-down operation of the MPPT circuit 22A have been mainly described. However, the MPPT circuits 22B and 22C can also perform the step-up operation and the step-down operation by being controlled by the control section 28 in the same manner as for the MPPT circuit 22A. For example, the MPPT circuit 22B can perform the step-up operation of stepping up the voltage applied between the pair of electricity conducting paths 13A and 13B and applying the stepped-up voltage between the pair of electricity conducting paths 14A and 14B, and can perform the step-down operation of stepping down the voltage applied between the pair of electricity conducting paths 14A and 14B and applying the stepped-down voltage between the pair of electricity conducting paths 13A and 13B. The MPPT circuit 22C can perform the step-up operation of stepping up the voltage applied between the pair of electricity conducting paths 15A and 15B and applying the stepped-up voltage between the pair of electricity conducting paths 16A and 16B, and can perform the step-down operation of stepping up the voltage applied between the pair of electricity conducting paths 16A and 16B and applying the stepped-up voltage between the pair of electricity conducting paths 15A and 15B. The control section 28 can perform the MPPT control for the MPPT circuits 22B and 22C as well by the same method as for the MPPT circuit 22A.

In addition, the power control device 10 determines that an abnormality has occurred, on the basis of the current inputted from the solar cell panels 2. The abnormality determination section 29 of the power control device 10 determines that an abnormality has occurred, on the basis of the current on the input side. The “current on the input side” corresponds to an example of the change target.

During the tracking control, the abnormality determination section 29 changes the current on the input side of the power conversion section 30 in a prescribed target period such that the current on the input side increases and decreases between two values set beforehand. The abnormality determination section 29 performs a changing process of changing the change target in the target period.

The target period is started when a determination start condition set beforehand is satisfied. The determination start condition may be, for example, elapse of a prescribed time from the start of the tracking control, coming of a prescribed time set beforehand, or any of other conditions.

When the tracking control is stated, the abnormality determination section 29 repeatedly determines whether or not the determination start condition is satisfied. In the case where the abnormality determination section 29 determines that the determination start condition is satisfied, the abnormality determination section 29 performs the changing process, thereby changing the current on the input side of the power conversion section 30.

The abnormality determination section 29 changes the current on the input side by, for example, changing the duty of the PWM signal given to each of the drive circuits provided in the MPPT circuits 22A, 22B, and 22C (in the first MPPT circuit 22A shown in FIG. 2, the drive circuit 38). In the tracking control, the above-descried control section 28 causes the power conversion section 30 to perform the step-up operation such that the current on the input side becomes equal to the target current. The abnormality determination section 29 changes the duty of the PWM signal given to each drive circuit by, for example, changing the target current.

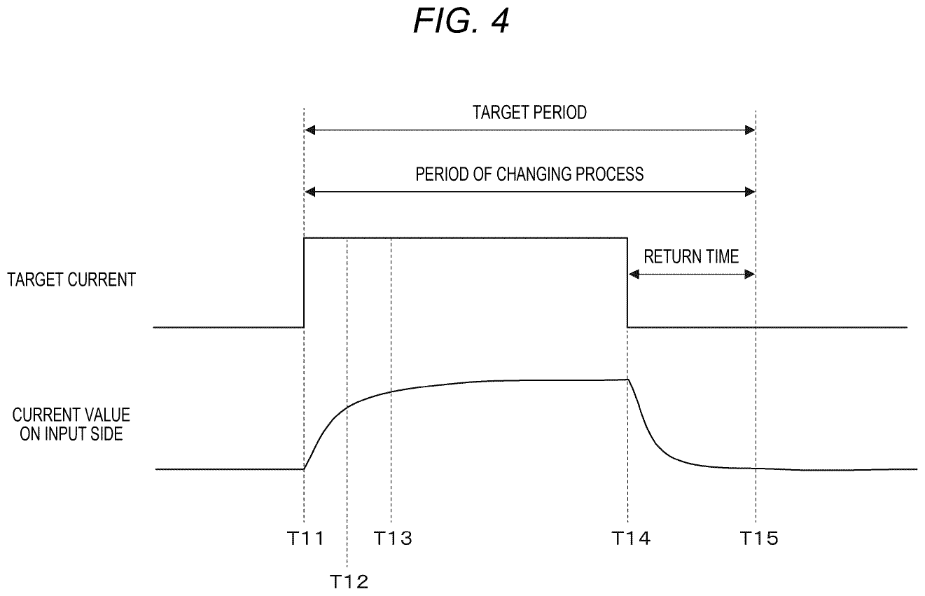

As shown in the lower row of FIG. 4, the abnormality determination section 29 changes the current on the input side such that a pulse wave of current is generated. The pulse wave may be a rectangular wave or may not be a rectangular wave. The abnormality determination section 29 detects the current value on the input side (hereinafter referred to as the input-side current value) at the time when the target period starts (timing T11 in FIG. 4) and determines a target current for changing on the basis of the detected value. For example, the abnormality determination section 29 uses, as the target current for changing, a value obtained by adding a prescribed addition value to the detected value. As shown in the upper row of FIG. 4, the abnormality determination section 29 temporarily changes the target current to the determined target current for changing. Namely, the abnormality determination section 29 changes the target current to the target current for changing and then changes the target current to the original target current (the target current at the beginning of the target period) after elapse of a certain period of time. As a result, a current in the form of a pulse flows to the input side of the power conversion section 30.

The abnormality determination section 29 determines that an abnormality has occurred, on the basis of the input-side current value at the time when the input-side current is changing with the change of the target current. As shown in FIG. 4, the response of the input-side current value is affected by the impedances of the solar cell panels 2 and the impedances of the electricity conducting paths (for example, the electricity conducting paths 11A, 11B, 13A, 13B, 15A, and 15B) through which power is transferred from the solar cell panels 2, when the target current changes. The abnormality determination section 29 determines that an abnormality has occurred by utilizing this phenomenon.

The abnormality determination section 29 performs a measurement process of measuring the input-side current value at the time when the input-side current value is changing with the change of the target current. The abnormality determination section 29 measures the input-side current value after elapse of a prescribed time after the target current has been changed. The prescribed time is preferably 1 second or shorter, more preferably 100 ms, further preferably 10 ms or shorter. The abnormality determination section 29 determines whether or not the measured current value falls within a normal range.

For example, the abnormality determination section 29 determines whether or not the input-side current value at timing T12 (when a first time period has elapsed after the target current had been changed) falls within the normal range. In addition, the abnormality determination section 29 determines whether or not the input-side current value at timing T13 (when a second time period has elapsed after the target current had been changed) falls within the normal range. The second time period is longer than the first time period. The normal range varies with the time elapsed after the target current has been changed. The normal range may be determined on the basis of the input-side current value at the beginning of the target period (timing T11 in FIG. 4), may be determined on the basis of the target current before having changed at the beginning of the target period, or may be determined on the basis of the target current after having changed at the beginning of the target period.

The normal range is determined, for example, as follows. A corresponding value which corresponds to an elapsed time is added to, for example, the target current before having changed. A value obtained by adding an upper limit calculation value to the corresponding value is used as an upper limit of the normal range, and a value obtained by subtracting a lower limit calculation value from the corresponding value is used as a lower limit of the normal range. Corresponding values, upper limit calculation values, and lower limit calculation values, which correspond to different elapsed times, are determined beforehand. The upper limit calculation value and the lower limit calculation value may be determined for each elapsed time or may be common among the different elapsed times.

The abnormality determination section 29 returns the target current to the original target current (the target current at the beginning of the target period) at timing T14 (when a certain period has elapsed after the target current had been changed). At timing T15 (when a return time determined beforehand has elapsed after the target current had been returned to the original target current (the target current at the beginning of the target period), the changing process ends, and the target period ends. The return time is a time necessary for the input-side current value to return to the original target current (the target current at the beginning of the target period).

In the present embodiment, the changing process is performed only one time in the target period. Therefore, the period of the changing process coincides with the target period.

The abnormality determination section 29 determines that an abnormality has occurred, on the condition that the amount of change of the input-side power occurred in the changing process (namely, the amount of change of the input-side power occurred in the target period) is equal to or less than a determination value. The abnormality determination section 29 measures the input-side power at the beginning of the changing process and the input-side power at the end of the changing process, and calculates their difference as a change amount. The abnormality determination section 29 determines that an abnormality has occurred in the case where the amount of change of the input-side power occurred in the changing process (namely, the amount of change of the input-side power occurred in the target period) is equal to or less than the determination value, and the input-side current value at the time when the input-side current is changing with the change of the target current falls outside the normal range.

In addition, each of the above-described solar cell panels 2 includes a plurality of solar cell modules (not shown) connected in series and a bypass diode (not shown) connected parallel to the solar cell modules. The control section 28 is configured to calculate the absolute value of a differential conductance di/dv on an I-V curve which represents the correlation between the current and the voltage outputted from each solar cell panel 2. In the case where, in the search control, the differential conductance di/dv becomes equal to or smaller than a threshold value set beforehand, the control section 28 determines that the bypass diode has operated and performs the search control and the tracking control within the range of voltage or current on the input side within which the bypass diode does not operate.

For example, the control section 28 is configured to calculate a voltage which constitutes a step in the I-V curve representing the correlation between the current and the voltage outputted from each solar cell panel 2, the step being generated when the differential conductance di/dv is equal to or smaller than the threshold value. The above-described voltage which constitutes a step includes a first step voltage generated when the vehicle is stopped and a second step voltage generated when the vehicle is travelling. The control section 28 determines whether or not the first step voltage and the second step voltage coincide with each other. In the case where the control section 28 determines that the first step voltage and the second step voltage coincide with each other, the control section 28 performs the search control and the tracking control within a range of voltage smaller than the voltage value at the time when the first step voltage and the second step voltage coincide with each other. For example, the control section 28 performs the above-described search control by the method disclosed in JP2017-162171A.

### 1-4. Example of Effect

The power control device 10 can perform the detection of the maximum power point more finely by the second search control after performing the detection of the maximum power point relatively roughly by the first search control. In the second search control, the detection of the maximum power point is performed in a current region rendered closer to the maximum power point detected by the first search control. Therefore, the detection can be performed faster as compared with the method in which the detection is performed in a current region similar to that in the first search control. Furthermore, in the power control device 10, the length of the period of each step is set to be less than 100 ms in both of the first search control and the second search control. Therefore, the increasing speed of current can be made larger in both the first search control and the second search control.

The power control device 10 changes the input-side current in the target period and determines that an abnormality has occurred, on the basis of a change of the change target in the target period. Thus, the power control device 10 can determine an abnormality of the solar cell panels 2 or the electricity conducting path for transferring the power from the solar cell panels 2.

The abnormality determination section 29 determines that an abnormality has occurred, on the basis of the input-side current value at the time when the input-side current is changing with the change of the target current. Accordingly, the power control device 10 can determine that an abnormality has occurred on the basis of the results of the determination as to whether or not the input-side current value is changing normally.

The abnormality determination section 29 performs the changing process of changing the input-side current in the target period and the measurement process of measuring the input-side current value at the time when the input-side current is changing with the change of the target current. The abnormality determination section 29 determines that an abnormality has occurred, on the condition that the amount of change of the input-side power occurred in the changing process is equal to or less than the determination value. Accordingly, the power control device 10 can easily avoid erroneous determination of abnormality due to changes in the external environment in the middle of the changing process.

The abnormality determination section 29 determines that an abnormality has occurred, on the condition that the amount of change of the voltage, current, or power on the input side occurred in the target period is equal to or less than the determination value. The power control device 10 can easily avoid erroneous determination of abnormality due to changes in the external environment in the middle of the target period.

The abnormality determination section 29 is configured by the same control circuit as the control section 28. Accordingly, in the power control device 10, the configurations of the control section 28 and the abnormality determination section 29 can be simplified by constituting the control section 28 and the abnormality determination section 29 by the same control circuit.

In a state in which the bypass diode operates at all times, the power control device 10 can perform the search control by lowering the voltage to a voltage at which the bypass diode does not operate.

### 2. Second Embodiment

In the second embodiment, there will be described an example in which the abnormality determination section determines that an abnormality has occurred, on the basis of results obtained by measuring the input-side current value a plurality of times in the target period. Notably, since the configuration of the power control device of the second embodiment is the same as the configuration described in the first embodiment and shown in FIGS. 1 and 2, the power control device of the second embodiment will be described with reference to FIGS. 1 and 2.

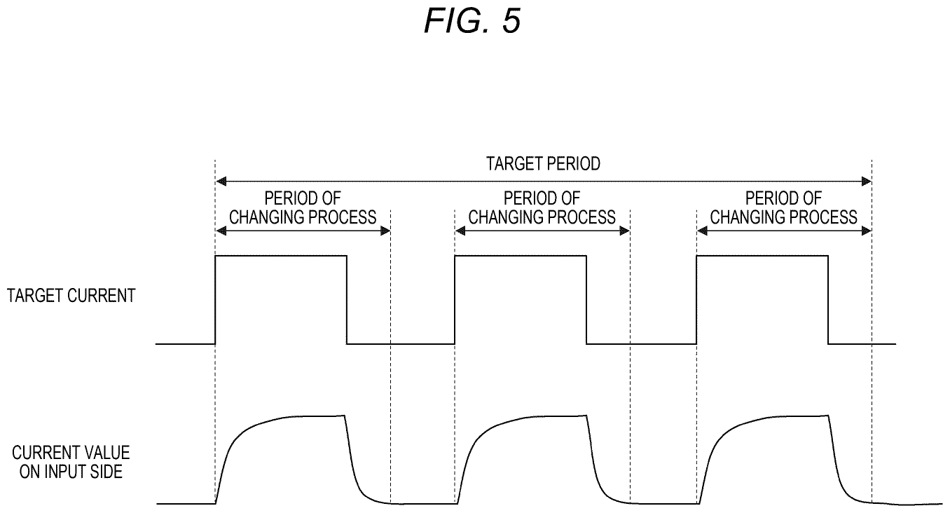

In the second embodiment, as shown in FIG. 5, the abnormality determination section 29 performs the changing process, which changes the input-side current, a plurality of times in the target period. Every time the changing process is performed, the abnormality determination section 29 performs the measurement process of measuring the input-side current value which is changing with the change of the target current. In the measurement process, the abnormality determination section 29 measures the input-side current value at the time when the input-side current is changing with the change of the target current. The abnormality determination section 29 determines that an abnormality has occurred, on the basis of the average of measured values. The average of measured values may be the average of all the measured values or the average of some of the measured values. The abnormality determination section 29 determines whether or not the average of measured values falls within the normal range.

The abnormality determination section 29 determines that an abnormality has occurred, on the condition that the amount of change of the input-side power occurred in the target period is equal to or less than the determination value. The abnormality determination section 29 measures the input-side power at the beginning of the target period and the input-side power at the end of the target period, and calculates their difference as a change amount. The abnormality determination section 29 determines that an abnormality has occurred in the case where the amount of change of the input-side power occurred in the target period is equal to or less than the determination value, and the average of measured values falls outside the normal range.

Since the power control device 10 of the second embodiment determines that an abnormality has occurred, on the basis of the average of the plurality of values measured in the same target period, the power control device 10 can determine an abnormality more accurately.

### 3. Third Embodiment

In the third embodiment, there will be described an example in which the abnormality determination section determines that an abnormality has occurred, on the basis of the amplitude of the change target at the time when the change target is periodically changed in the target period. Notably, since the configuration of the power control device of the third embodiment is the same as the configuration described in the first embodiment and shown in FIGS. 1 and 2, the power control device of the third embodiment will be described with reference to FIGS. 1 and 2.

In the third embodiment, the abnormality determination section 29 determines that an abnormality has occurred, on the basis of the amplitude of the change target (specifically, the input-side current) at the time when the change target is periodically changed in the target period. The abnormality determination section 29 performs the changing process of changing the change target in the target period and the measurement process of measuring a value corresponding to the change.

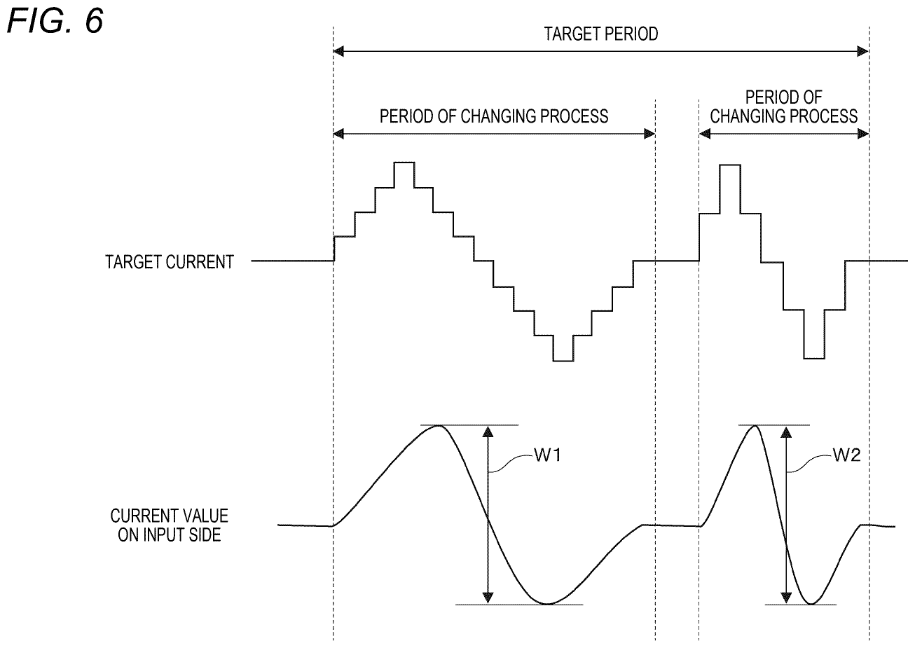

As shown in FIG. 6, in the changing process, the abnormality determination section 29 periodically changes the input-side current by increasing and decreasing the target current stepwise. The abnormality determination section 29 periodically changes the input-side current such that the input-side current increases and decreases from the original current value (the current value before being changed). In the measurement process, the abnormality determination section 29 measures the amplitude of the input-side current. The abnormality determination section 29 determines whether or not the measured amplitude falls within a normal range. The normal range may be determined beforehand or may be determined on the basis of the original current value, or the like.

The abnormality determination section 29 periodically changes the input-side current at a plurality of frequences in the target period and determines that an abnormality has occurred, on the basis of a change at each frequency. For example, as shown in FIG. 6, the abnormality determination section 29 performs a changing process of periodically changing the input-side current at a first frequency and then performs a changing process of periodically changing the input-side current at a second frequency. In FIG. 6, the first frequency is lower than the second frequency. However, the first frequency may be higher than the second frequency.

The abnormality determination section 29 measures a first amplitude W1 at the time when the input-side current is periodically changed at the first frequency. The abnormality determination section 29 determines whether or not the first amplitude W1 falls within a first normal range. The abnormality determination section 29 determines that an abnormality has occurred, on the condition that the amount of change of the input-side power occurred in the changing process is equal to or less than the determination value. The abnormality determination section 29 measures the input-side power at the beginning of the changing process and the input-side power at the end of the changing process, and calculates their difference as a change amount. The abnormality determination section 29 determines that an abnormality has occurred in the case where the amount of change of the input-side power occurred in the changing process is equal to or less than the determination value, and the first amplitude W1 of the input-side current in the changing process falls outside the first normal range.

The abnormality determination section 29 measures a second amplitude W2 at the time when the input-side current is periodically changed at the second frequency. The abnormality determination section 29 determines whether or not the second amplitude W2 falls within a second normal range. The abnormality determination section 29 determines that an abnormality has occurred, on the condition that the amount of change of the input-side power occurred in the changing process is equal to or less than the determination value. The abnormality determination section 29 measures the input-side power at the beginning of the changing process and the input-side power at the end of the changing process, and calculates their difference as a change amount. The abnormality determination section 29 determines that an abnormality has occurred in the case where the amount of change of the input-side power occurred in the changing process is equal to or less than the determination value, and the second amplitude W2 of the input-side current in the changing process falls outside the second normal range.

The abnormality determination section 29 may determine that an abnormality has occurred, on the condition that the amount of change of the input-side power occurred in the target period is equal to or less than the determination value. The abnormality determination section 29 measures the input-side power at the beginning of the target period and the input-side power at the end of the target period, and calculates their difference as a change amount. The abnormality determination section 29 may determine that an abnormality has occurred in the case where the amount of change of the input-side power occurred in the target period is equal to or less than the determination value, and the amplitude in one of the changing processes falls outside the normal range.

The power control device 10 of the third embodiment can determine that an abnormality has occurred in the case where the amplitude of the input-side current is abnormal.

The frequency at which an abnormality of response is observed changes depending on the cause of the abnormality. Since the power control device 10 of the third embodiment periodically changes the input-side current at a plurality of frequencies and determines that an abnormality has occurred, on the basis of a change at each frequency, the power control device 10 can determine, for a plurality of causes of the abnormality, that an abnormality has occurred.

In the case where the abnormality determination section 29 determines in one of the changing processes that an abnormality has occurred, the abnormality determination section 29 may output to the outside a piece of information which enables identification of the frequency at which the abnormality has occurred. By virtue of this, the power control device 10 of the third embodiment can facilitate identification of the cause of the abnormality on the outside.

### <Other Embodiments>

The present invention is not limited to the embodiments described by the above description and the drawings, and, for example, the following embodiments fall within the technical scope of the present invention. Also, various features of the above-described embodiments and the following embodiments may be combined freely so long as no conflict occurs.

In each of the embodiments described above, the change target is current on the input side. However, the change target may be voltage on the input side or power on the input side.

The abnormality determination section may be configured to determine that an abnormality has occurred, on the condition that the amount of change of the voltage or power on one side, which change occurred in the changing process, is equal to or smaller than the determination value. The abnormality determination section may be configured to determine that an abnormality has occurred, on the condition that the amount of change of the voltage or power on one side, which change occurred in the target period, is equal to or smaller than the determination value.

The abnormality determination section may determine that an abnormality has occurred, irrespective of the amount of change of the voltage, current, or power on one side, which change occurred in the target period. For example, the abnormality determination section may determine that an abnormality has occurred, only on the condition that the input-side current value at the time when the input-side current is changing with the change of the target current falls outside the normal range.

In each of the embodiments described above, the side (input side) where the pair of electricity conducting paths 11A and 11B are present is one side. However, the side (output side) where the pair of electricity conducting paths 12A and 12B are present may be one side.

In each of the embodiments described above, the adjustment target is the “current on one side.” However, the adjustment target may be the “voltage on one side.” In each of the embodiments described above, a configuration of increasing the adjustment target stepwise by a predetermined width is employed. However, a configuration of decreasing the adjustment target stepwise by a predetermined width may be employed. In addition, in the first search control, the adjustment target may be increased stepwise by a predetermined width, and in the second search control, the adjustment target may be decreased stepwise by a predetermined width. Alternatively, in the first search control, the adjustment target may be decreased stepwise by a predetermined width, and in the second search control, the adjustment target may be increased stepwise by a predetermined width.

In each of the embodiments described above, the power conversion section 30 is a circuit which can step up the voltage applied between the pair of electricity conducting paths 11A and 11B and apply a relatively higher voltage between the pair of electricity conducting paths 12A and 12B. However, the power conversion section 30 may be a circuit which can step down the voltage applied between the pair of electricity conducting paths 11A and 11B and apply a relatively lower voltage between the pair of electricity conducting paths 12A and 12B. In this case as well, the control section 28 can perform the MPPT control for the power conversion section 30.

In each of the embodiments described above, the control section 28 regularly performs the search control at constant intervals. However, the start timing of the search control is not limited to timings at constant intervals, and may be a timing at which other prescribed conditions are satisfied. For example, the start timing may be a timing at which one of current, voltage, and power (parameters) on the input side or the output side of the power conversion section 30 has changed a certain value or more during the tracking control or a sudden change timing at which the above-described parameter changes a predetermined value or more within a unit time.

In each of the embodiments described above, the power conversion section 30 is configured by a chopper circuit. However, the chopper circuit may be changed to any of other DC-DC converters which can perform step-down operation and/or step-up operation such as a forward-type isolated DC-DC converter and a flyback-type isolated DC-DC converter.

In each of the embodiments described above, a circuit or an electrical component is not present between each of the solar cell panels 2A, 2B, and 2C and each of the MPPT circuits 22A, 22B, and 22C. However, a circuit or an electrical component such as a relay, a fuse, or a filter may be provided. The input power inputted to the power conversion section 30 may be supplied directly from the solar cell panels 2 or supplied via an intermediate circuit of some kind.

In each of the embodiments described above, a drive battery (battery for the main engine) made of a lithium ion battery is exemplified as the battery 6. However, the battery 6 is not limited thereto and may be a battery for auxiliary equipment or a lead battery.

In each of the embodiments described above, an example in which three solar cell panels are used and three MPPT circuits are provided has been shown. However, the number of the solar cell panels may be one, two, or four or more. In any case, it is sufficient that MPPT circuits are provided to correspond to the solar cell panels.

In the first embodiment described above, the abnormality determination section 29 is configured to change the current on the input side such that a pulse wave of current is generated. However, the configuration of the abnormality determination section 29 is not limited to that configuration. For example, the abnormality determination section 29 may gently change the current on the input side. For example, the abnormality determination section 29 may gently increase the current on the input side and then gently decrease the current on the input side. Alternatively, the abnormality determination section 29 may gently decrease the current on the input side and then gently increase the current on the input side.

Notably, the embodiments disclosed this time should be considered to be illustrative and not to be restrictive in all aspects. The scope of the present invention is not limited to the embodiments disclosed this time, and it is intended that the present invention encompasses all modifications within the range shown by the claims and the range of equivalents of the claims.

### REFERENCE SIGNS LIST

1: vehicle
1A: on-vehicle system
2: solar cell panel
2A: solar cell panel
2B: solar cell panel
2C: solar cell panel
6: battery
8: state monitoring device
10: power control device
11A, 11B, 12A, 12B, 13A, 13B, 14A, 14B, 15A, 15B, 16A, 16B, 51, 52, 61, 62: electricity conducting path
22A: first MPPT circuit
22B: second MPPT circuit
22C: third MPPT circuit
24: capacitor
26: isolated converter
28: control section
29: abnormality determination section
30: power conversion section
31: first element
32: second element
34: inductor
38: drive circuit
41: detection section
42: detection section

1. A power control device which controls power inputted from a solar cell panel and determines that an abnormality has occurred, on the basis of voltage, current, or power inputted from the solar cell panel, the power control device comprising:
a power conversion section which converts and outputs the voltage inputted from the solar cell panel;
a control section which performs tracking control for the power conversion section after performing search control for the power conversion section; and
an abnormality determination section which determines that an abnormality has occurred,
wherein voltage or current on one side of the power conversion section, the one side being an input side or an output side of the power conversion section, is used as an adjustment target in the search control, and the search control changes the adjustment target stepwise by a prescribed width in each of steps, and detects, as a maximum power, a power which is the maximum among powers on the one side in the steps,
wherein the tracking control causes the power on the one side of the power conversion section to follow the maximum power detected by the search control, and
wherein, in the tracking control, the abnormality determination section changes a change target, which is one of voltage, current, and power on the input side of the power conversion section, in a prescribed target period such that the change target increases and decreases between two values set beforehand and determines that an abnormality has occurred, on the basis of a change of the change target in the target period.

2. The power control device according to claim 1, wherein, in the target period, the abnormality determination section performs a plurality of times a process of measuring a value corresponding to a change of the change target at the time when the change target is changed, and the abnormality determination section determines that an abnormality has occurred, on the basis of the average of measured values.

3. The power control device according to claim 1, wherein the abnormality determination section periodically changes the change target at a plurality of frequencies in the target period and determines that an abnormality has occurred, on the basis of a change of the change target at each frequency.

4. The power control device according to claim 1, wherein the abnormality determination section determines that an abnormality has occurred, on the basis of the value of the change target at the time when the change target is changing.

5. The power control device according to claim 1, wherein the abnormality determination section determines that an abnormality has occurred, on the basis of the amplitude of the change target at the time when the change target is periodically changed in the target period.

6. The power control device according to claim 1,
wherein the power control device controls power inputted from the solar cell panel mounted on a vehicle,
wherein the solar cell panel includes a plurality of solar cell modules connected in series and a bypass diode connected in parallel to the solar cell modules,
wherein the control section is configured to calculate a differential conductance di/dv on an I-V curve which represents the correlation between current and voltage outputted from the solar cell panel, and
wherein, in the case where the absolute value of the differential conductance di/dv becomes equal to or smaller than a previously set threshold value in the search control, the control section determines that the bypass diode has operated and performs the search control and the tracking control within a range of voltage or current on the input side within which the bypass diode does not operate.

7. The power control device according to claim 1, wherein the abnormality determination section performs a changing process of changing the change target in the target period and a measurement process of measuring a value corresponding to a change of the charge target, and the abnormality determination section determines that an abnormality has occurred, on the condition that an amount of change of voltage, current, or power on the one side, which change occurred in the changing process, is equal to or smaller than a determination value.

8. The power control device according to claim 1, wherein the abnormality determination section determines that an abnormality has occurred, on the condition that an amount of change of voltage, current, or power on the one side, which change occurred in the target period, is equal to or smaller than a determination value.

9. The power control device according to claim 1, wherein the abnormality determination section and the control section are configured by a common control circuit.
